(19) United States
(12) Patent Application Publication
(10) Pub. No.: US 2023/0267336 A1
(43) Pub. Date: Aug. 24, 2023

(54) Method For Training A Neural Network Model For Semiconductor Design

(71) Applicant: MakinaRocks Co., Ltd., Seoul (KR)

(72) Inventor: Kyeongmin WOO, Seoul (KR)

(73) Assignee: MakinaRocks Co., Ltd., Seoul (KR)

(21) Appl. No.: 18/102,403

(22) Filed: Jan. 27, 2023

(30) Foreign Application Priority Data
Feb. 18, 2022 (KR) 10-2022-0021293
Sep. 1, 2022 (KR) 10-2022-0110466

(51) Int. Cl. G06N 3/092; G06F 30/392

(52) U.S. Cl. CPC G06N 3/092; G06F 30/392

(57) ABSTRACT

Disclosed is a method for a semiconductor design, performed by one or more processors of a computing device according to an exemplary embodiment of the present disclosure. The method includes identifying an area in which the semiconductor device cannot be disposed based on the information about the semiconductor device to be disposed, using the neural network model, and calculating a reward for the neural network model based on the area in which the semiconductor device cannot be disposed.

### CROSS-REFERENCE TO RELATED APPLICATIONS

This application claims priority to and the benefit of Korean Patent Application No. 10-2022-0021293 filed in the Korean Intellectual Property Office on Feb. 18, 2022, the entire contents of which are incorporated herein by reference.

### TECHNICAL FIELD

The present disclosure relates to a neural network model training method for a semiconductor design, and more particularly, to a method of determining a reward related to the training of a neural network model for a semiconductor design.

This study was carried out as a part of the private intelligent information service expansion project of the Ministry of Science and ICT and the Information and Communication Industry Promotion Agency (A0903-21-1021, development of AI based semiconductor design automation system).

### BACKGROUND ART

Despite technological advances, the reality is that a logical design of semiconductors which can be seen as an integral part of the high-tech industry is generally performed by engineers using a rule based software. Accordingly, the logical design of the semiconductor should be performed based on the experience of the engineers and the design speed may greatly vary depending on the skill of the engineers. Further, actually, it is very difficult for the engineer to efficiently place tens to millions of semiconductor devices while keeping the connection relationship of the semiconductor devices in mind. That is, since the current semiconductor designing process depends on the engineer's experience and intuition, it is difficult to maintain a consistent design quality and a considerable amount of time and money to be invested for the design is inevitably required.

Evaluation performed for tens to millions of disposed semiconductor devices has also high complexity. It takes a lot of time to evaluate the placement of tens to millions of semiconductor devices so that study for a semiconductor device placement evaluating method to reduce the complexity of the operation is necessary.

Korean Patent No. 10-0296183 (Oct. 22, 2001) discloses a design method of a semiconductor integrated circuit.

### SUMMARY OF THE INVENTION

An object to be achieved by the present disclosure is to provide a method for determining a reward with regard to the training of a neural network model for a semiconductor design.

In order to achieve the above-described objects, the method performed by a computing device according to an exemplary embodiment of the present disclosure will be described. The method includes identifying an area in which a semiconductor device is not disposed based on information about the semiconductor device to be disposed, using a neural network model; and calculating a reward for the neural network model based on the area in which the semiconductor device cannot be disposed.

Alternatively, the information about the semiconductor device includes size information including at least one of a width or a height of the semiconductor device and type information indicating whether the semiconductor device is a macro cell.

Alternatively, the information about the semiconductor device may include index information regarding the placement order of the semiconductor device.

Alternatively, the neural network model is trained by means of reinforcement learning based on a state including information about the semiconductor device, an action to dispose the semiconductor devices in a canvas in a predetermined order, and a reward for the action.

Alternatively, the neural network model identifies the area in which the semiconductor device is not able to be disposed based on the placement information of one or more semiconductor devices disposed prior to the semiconductor device and a placement order of the semiconductor devices.

Alternatively, the reward for the neural network model includes a negative reward determined in proportion to a size of the area in which the semiconductor device is not able to be disposed.

Alternatively, the reward for the neural network model includes: a first negative reward determined based on a size of an area in which the first semiconductor device is not able to be disposed; and a second negative reward determined based on a size of an area in which a second semiconductor device to be disposed after the first semiconductor device is not able to be disposed.

Alternatively, the reward for the neural network model includes a reward corresponding to a lower limit of a negative reward when an area in which the semiconductor device cannot be disposed corresponds to an entire area.

Alternatively, when the area in which the semiconductor device cannot be disposed corresponds to the entire area, the neural network model ends the collection of information about the reinforcement learning.

In order to achieve the above-described objects, according to an aspect of the present disclosure, disclosed is a computer program stored in a computer readable storage medium. The computer program causes one or more processors to perform operations for a semiconductor design when the computer program is executed by the one or more processors and the operations include an operation of identifying an area in which a semiconductor device is not disposed based on information about the semiconductor device to be disposed, using a neural network model; and an operation of calculating a reward for the neural network model based on the area in which the semiconductor device cannot be disposed,

In order to achieve the object as described above, according to an aspect of the present disclosure, a computing device is disclosed. The device includes at least one processor and a memory, the processor is configured to identify an area in which a semiconductor device is not disposed based on information about the semiconductor device to be disposed, using a neural network model; and calculate a reward for the neural network model based on the area in which the semiconductor device cannot be disposed,

According to the present disclosure, a method for determining a reward with regard to the training of a neural network model for a semiconductor design, thereby providing an optimized semiconductor design technique utilizing a neural network model.

### BRIEF DESCRIPTION OF THE DRAWINGS

FIG. 1 is a block diagram of a computing device for setting a reinforcement learning reward of a neural network model according to an exemplary embodiment of the present disclosure;

FIG. 2 is a schematic view illustrating a network function according to an exemplary embodiment of the present disclosure;

FIG. 3 is a conceptual view for explaining a reinforcement learning process of a neural network model according to an exemplary embodiment of the present disclosure;

FIG. 4 is a flowchart illustrating a neural network model training method for a semiconductor design according to an exemplary embodiment of the present disclosure;

FIG. 5 is a flowchart illustrating a method for evaluating placement of semiconductor devices according to an exemplary embodiment of the present disclosure;

FIG. 6 is an algorithm flowchart illustrating a step A of a step of calculating and assigning a reward for a neural network model according to an exemplary embodiment of the present disclosure;

FIG. 7 is an algorithm flowchart illustrating a step B of a step of calculating and assigning a reward for a neural network model according to an exemplary embodiment of the present disclosure;

FIG. 8 illustrates a simple and general schematic view of an exemplary computing environment in which exemplary embodiments of the present disclosure are embodied.

### DETAILED DESCRIPTION OF THE EMBODIMENT

Various exemplary embodiments will now be described with reference to drawings. In the present specification, various descriptions are presented to provide appreciation of the present disclosure. However, it is apparent that the exemplary embodiments can be executed without the specific description.

“Component”, “module”, “system”, and the like which are terms used in the specification refer to a computer-related entity, hardware, firmware, software, and a combination of the software and the hardware, or execution of the software. For example, the component may be a processing procedure executed on a processor, the processor, an object, an execution thread, a program, and/or a computer, but is not limited thereto. For example, both an application executed in a computing device and the computing device may be the components. One or more components may reside within the processor and/or a thread of execution. One component may be localized in one computer. One component may be distributed between two or more computers. Further, the components may be executed by various computer-readable media having various data structures, which are stored therein. The components may perform communication through local and/or remote processing according to a signal (for example, data transmitted from another system through a network such as the Internet through data and/or a signal from one component that interacts with other components in a local system and a distribution system) having one or more data packets, for example.

The term “or” is intended to mean not exclusive “or” but inclusive “or”. That is, when not separately specified or not clear in terms of a context, a sentence “X uses A or B” is intended to mean one of the natural inclusive substitutions. That is, the sentence “X uses A or B” may be applied to any of the case where X uses A, the case where X uses B, or the case where X uses both A and B. Further, it should be understood that the term “and/or” used in this specification designates and includes all available combinations of one or more items among enumerated related items.

It should be appreciated that the term “comprise” and/or “comprising” means presence of corresponding features and/or components. However, it should be appreciated that the term “comprises” and/or “comprising” means that presence or addition of one or more other features, components, and/or a group thereof is not excluded. Further, when not separately specified or it is not clear in terms of the context that a singular form is indicated, it should be construed that the singular form generally means “one or more” in this specification and the claims.

The term “at least one of A or B” should be interpreted to mean “a case including only A”, “a case including only B”, and “a case in which A and B are combined”.

Those skilled in the art need to recognize that various illustrative logical blocks, configurations, modules, circuits, means, logic, and algorithm steps described in connection with the exemplary embodiments disclosed herein may be additionally implemented as electronic hardware, computer software, or combinations of both sides. To clearly illustrate the interchangeability of hardware and software, various illustrative components, blocks, configurations, means, logic, modules, circuits, and steps have been described above generally in terms of their functionalities. Whether the functionalities are implemented as the hardware or software depends on a specific application and design restrictions given to an entire system. Skilled artisans may implement the described functionalities in various ways for each particular application. However, such implementation decisions should not be interpreted as causing a departure from the scope of the present disclosure.

The description of the presented exemplary embodiments is provided so that those skilled in the art of the present disclosure use or implement the present disclosure. Various modifications to the exemplary embodiments will be apparent to those skilled in the art. Generic principles defined herein may be applied to other embodiments without departing from the scope of the present disclosure. Therefore, the present disclosure is not limited to the exemplary embodiments presented herein. The present disclosure should be analyzed within the widest range which is coherent with the principles and new features presented herein.

In the present disclosure, a network function and an artificial neural network and a neural network may be interchangeably used.

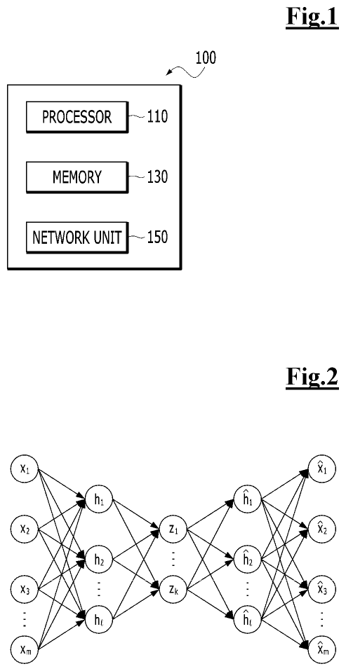

FIG. 1 is a block diagram of a computing device for setting a reinforcement learning reward of a neural network model for a semiconductor design according to an exemplary embodiment of the present disclosure.

A configuration of the computing device 100 illustrated in FIG. 1 is only an example shown through simplification. In an exemplary embodiment of the present disclosure, the computing device 100 may include other components for performing a computing environment of the computing device 100 and only some of the disclosed components may constitute the computing device 100. The computing device 100 may include a processor 110, a memory 130, and a network unit 150.

The processor 110 may be constituted by one or more cores and may include processors for data analysis and deep learning, which include a central processing unit (CPU), a general purpose graphics processing unit (GPGPU), a tensor processing unit (TPU), and the like of the computing device. The processor 110 may read a computer program stored in the memory 130 to perform data processing for machine learning according to an exemplary embodiment of the present disclosure. According to an exemplary embodiment of the present disclosure, the processor 110 may perform a calculation for learning the neural network. The processor 110 may perform calculations for learning the neural network, which include processing of input data for learning in deep learning (DL), extracting a feature in the input data, calculating an error, updating a weight of the neural network using backpropagation, and the like. At least one of the CPU, GPGPU, and TPU of the processor 110 may process learning of a network function. For example, both the CPU and the GPGPU may process the learning of the network function and data classification using the network function. Further, in an exemplary embodiment of the present disclosure, processors of a plurality of computing devices may be used together to process the learning of the network function and the data classification using the network function. Further, the computer program executed in the computing device according to an exemplary embodiment of the present disclosure may be a CPU, GPGPU, or TPU executable program.

The processor 110 according to the exemplary embodiment of the present disclosure performs operations of recognizing information about a semiconductor device for a semiconductor design, identifying an area available to dispose the device, and calculating a reward for reinforcement learning of a neural network model based on the identified area. At this time, the information about the semiconductor device may be information about the device itself or information about a placement order of the device. For example, the processor 110 identifies an area in which the semiconductor device is not able to be disposed, based on the information about the semiconductor device to be disposed, using a neural network model. At this time, the information about the device may be at least one of size information including at least one of a width or a height of the semiconductor device or type information of the semiconductor device. Further, the information about the device may be index information regarding the placement order of the semiconductor device.

According to an exemplary embodiment of the present disclosure, the processor 110 trains the neural network model by means of reinforcement learning based on a state including information about the semiconductor device, an action of disposing the semiconductor devices in a predetermined order, and the reward based on the action.

The processor 110 performs an operation of identifying an area in which the semiconductor device is not able to be disposed based on the information about the semiconductor device to be disposed using a neural network model and calculates a reward for the neural network model based on the area in which the semiconductor device is not able to be disposed to return the reward together with the state. By doing this, the neural network model performs the action according to a next cycle to perform the reinforcement learning on the neural network model.

According to an exemplary embodiment of the present disclosure, the memory 130 may include at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The computing device 100 may operate in connection with a web storage performing a storing function of the memory 130 on the Internet. The description of the memory is just an example and the present disclosure is not limited thereto. The network unit 150 according to an exemplary embodiment of the present disclosure may use an arbitrary type known wired/wireless communication systems.

For example, the network unit 150 may receive information about the semiconductor device from the external system. At this time, the information received from the database may be learning data of the neural network model or inferring data. The information of the semiconductor device may include the information of the above-described example, but is not limited to the above-described example, and may be configured in various forms within a range that those skilled in the art understand.

The network unit 150 may transmit and receive information processed by the processor 110, a user interface, etc., through communication with the other terminal. For example, the network unit 150 may provide the user interface generated by the processor 110 to a client (e.g., a user terminal). Further, the network unit 150 may receive an external input of a user applied to the client and deliver the received external input to the processor 110. In this case, the processor 110 may process operations such as output, modification, change, addition, etc., of information provided through the user interface based on the external input of the user delivered from the network unit 150.

In the meantime, the computing device 100 according to the exemplary embodiment of the present disclosure is a computing system which transmits and receives information with the client, by means of communication and includes a server. At this time, the client may be an arbitrary form of a terminal accessible to the server. For example, the computing device 100 which is a server receives information for a semiconductor design from an external database to generate a logical design result and provides a user interface for the logical design result to the user terminal. At this time, the user terminal outputs the user interface received from the computing device 100 which is a server and receives or processes the information by means of the interaction with the user.

In an additional exemplary embodiment, the computing device 100 may include an arbitrary type of terminal which receives a data resource generated in an arbitrary server to perform additional information processing.

FIG. 2 is a schematic diagram illustrating a network function according to an exemplary embodiment of the present disclosure.

Throughout the present specification, a computation model, the neural network, a network function, and the neural network may be used as the same meaning. The neural network may be generally constituted by an aggregate of calculation units which are mutually connected to each other, which may be called nodes. The nodes may also be called neurons. The neural network is configured to include one or more nodes. The nodes (alternatively, neurons) constituting the neural networks may be connected to each other by one or more links.

In the neural network, one or more nodes connected through the link may relatively form the relationship between an input node and an output node. Concepts of the input node and the output node are relative and a predetermined node which has the output node relationship with respect to one node may have the input node relationship in the relationship with another node and vice versa. As described above, the relationship of the input node to the output node may be generated based on the link. One or more output nodes may be connected to one input node through the link and vice versa.

In the relationship of the input node and the output node connected through one link, a value of data of the output node may be determined based on data input in the input node. Here, a link connecting the input node and the output node to each other may have a weight. The weight may be variable and the weight is variable by a user or an algorithm in order for the neural network to perform a desired function. For example, when one or more input nodes are mutually connected to one output node by the respective links, the output node may determine an output node value based on values input in the input nodes connected with the output node and the weights set in the links corresponding to the respective input nodes.

As described above, in the neural network, one or more nodes are connected to each other through one or more links to form a relationship of the input node and output node in the neural network. A characteristic of the neural network may be determined according to the number of nodes, the number of links, correlations between the nodes and the links, and values of the weights granted to the respective links in the neural network. For example, when the same number of nodes and links exist and there are two neural networks in which the weight values of the links are different from each other, it may be recognized that two neural networks are different from each other.

The neural network may be constituted by a set of one or more nodes. A subset of the nodes constituting the neural network may constitute a layer. Some of the nodes constituting the neural network may constitute one layer based on the distances from the initial input node. For example, a set of nodes of which distance from the initial input node is n may constitute n layers. The distance from the initial input node may be defined by the minimum number of links which should be passed through for reaching the corresponding node from the initial input node. However, a definition of the layer is predetermined for description and the order of the layer in the neural network may be defined by a method different from the aforementioned method. For example, the layers of the nodes may be defined by the distance from a final output node.

The initial input node may mean one or more nodes in which data is directly input without passing through the links in the relationships with other nodes among the nodes in the neural network. Alternatively, in the neural network, in the relationship between the nodes based on the link, the initial input node may mean nodes which do not have other input nodes connected through the links. Similarly thereto, the final output node may mean one or more nodes which do not have the output node in the relationship with other nodes among the nodes in the neural network. Further, a hidden node may mean nodes constituting the neural network other than the initial input node and the final output node.

In the neural network according to an exemplary embodiment of the present disclosure, the number of nodes of the input layer may be the same as the number of nodes of the output layer, and the neural network may be a neural network of a type in which the number of nodes decreases and then, increases again from the input layer to the hidden layer. Further, in the neural network according to another exemplary embodiment of the present disclosure, the number of nodes of the input layer may be smaller than the number of nodes of the output layer, and the neural network may be a neural network of a type in which the number of nodes decreases from the input layer to the hidden layer. Further, in the neural network according to yet another exemplary embodiment of the present disclosure, the number of nodes of the input layer may be larger than the number of nodes of the output layer, and the neural network may be a neural network of a type in which the number of nodes increases from the input layer to the hidden layer. The neural network according to still yet another exemplary embodiment of the present disclosure may be a neural network of a type in which the neural networks are combined.

A deep neural network (DNN) may refer to a neural network that includes a plurality of hidden layers in addition to the input and output layers. When the deep neural network is used, the latent structures of data may be determined. That is, latent structures of photos, text, video, voice, and music (e.g., what objects are in the photo, what the content and feelings of the text are, what the content and feelings of the voice are) may be determined. The deep neural network may include a convolutional neural network (CNN), a recurrent neural network (RNN), an auto encoder, generative adversarial networks (GAN), a restricted Boltzmann machine (RBM), a deep belief network (DBN), a Q network, a U network, a Siam network, a Generative Adversarial Network (GAN), and the like. The description of the deep neural network described above is just an example and the present disclosure is not limited thereto.

In an exemplary embodiment of the present disclosure, the network function may include the auto encoder. The auto encoder may be a kind of artificial neural network for outputting output data similar to input data. The auto encoder may include at least one hidden layer and odd hidden layers may be disposed between the input and output layers. The number of nodes in each layer may be reduced from the number of nodes in the input layer to an intermediate layer called a bottleneck layer (encoding), and then expanded symmetrical to reduction to the output layer (symmetrical to the input layer) in the bottleneck layer. The auto encoder may perform non-linear dimensional reduction. The number of input and output layers may correspond to a dimension after preprocessing the input data. The auto encoder structure may have a structure in which the number of nodes in the hidden layer included in the encoder decreases as a distance from the input layer increases. When the number of nodes in the bottleneck layer (a layer having a smallest number of nodes positioned between an encoder and a decoder) is too small, a sufficient amount of information may not be delivered, and as a result, the number of nodes in the bottleneck layer may be maintained to be a specific number or more (e.g., half of the input layers or more).

The neural network may be learned in at least one scheme of supervised learning, unsupervised learning, semi supervised learning, or reinforcement learning. The learning of the neural network may be a process in which the neural network applies knowledge for performing a specific operation to the neural network.

The neural network may be learned in a direction to minimize errors of an output. The learning of the neural network is a process of repeatedly inputting learning data into the neural network and calculating the output of the neural network for the learning data and the error of a target and back-propagating the errors of the neural network from the output layer of the neural network toward the input layer in a direction to reduce the errors to update the weight of each node of the neural network. In the case of the supervised learning, the learning data labeled with a correct answer is used for each learning data (i.e., the labeled learning data) and in the case of the unsupervised learning, the correct answer may not be labeled in each learning data. That is, for example, the learning data in the case of the supervised learning related to the data classification may be data in which category is labeled in each learning data. The labeled learning data is input to the neural network, and the error may be calculated by comparing the output (category) of the neural network with the label of the learning data. As another example, in the case of the unsupervised learning related to the data classification, the learning data as the input is compared with the output of the neural network to calculate the error. The calculated error is back-propagated in a reverse direction (i.e., a direction from the output layer toward the input layer) in the neural network and connection weights of respective nodes of each layer of the neural network may be updated according to the back propagation. A variation amount of the updated connection weight of each node may be determined according to a learning rate. Calculation of the neural network for the input data and the back-propagation of the error may constitute a learning cycle (epoch). The learning rate may be applied differently according to the number of repetition times of the learning cycle of the neural network. For example, in an initial stage of the learning of the neural network, the neural network ensures a certain level of performance quickly by using a high learning rate, thereby increasing efficiency and uses a low learning rate in a latter stage of the learning, thereby increasing accuracy.

In learning of the neural network, the learning data may be generally a subset of actual data (i.e., data to be processed using the learned neural network), and as a result, there may be a learning cycle in which errors for the learning data decrease, but the errors for the actual data increase. Overfitting is a phenomenon in which the errors for the actual data increase due to excessive learning of the learning data. For example, a phenomenon in which the neural network that learns a cat by showing a yellow cat sees a cat other than the yellow cat and does not recognize the corresponding cat as the cat may be a kind of overfitting. The overfitting may act as a cause which increases the error of the machine learning algorithm. Various optimization methods may be used in order to prevent the overfitting. In order to prevent the overfitting, a method such as increasing the learning data, regularization, dropout of omitting a part of the node of the network in the process of learning, utilization of a batch normalization layer, etc., may be applied.

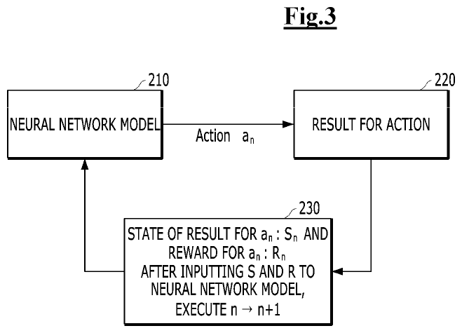

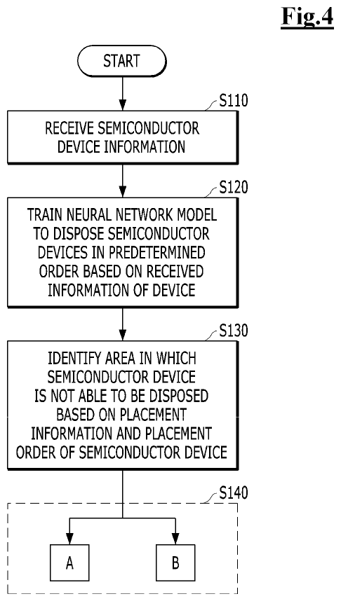

FIGS. 3 to 7 are conceptual views for explaining a reinforcement learning process of a neural network model according to an exemplary embodiment of the present disclosure.

The reinforcement learning is a learning method which trains the neural network model based on a reward calculated for an action selected by the neural network model to allow the neural network model to determine a better action based on a state. The state is a set of values representing how the situation is at the current timing and is understood as an input of the neural network model. The action refers to a decision according to an option to be taken by the neural network model and is understood as an output of the neural network model. The reward refers to a benefit followed when the neural network model performs any action and represents a value for evaluating the current state and the action. The reinforcement learning is understood as learning through trial and error because the action is rewarded. A reward given to the neural network model during the reinforcement learning process, may be a reward obtained by accumulating results of a plurality of actions. A neural network model which makes the return such as a reward itself or a total of rewards maximum in consideration of the reward according to several states and actions may be generated by the reinforcement learning.

Referring to FIG. 3, in the reinforcement learning, there is a result 220 for the actions of the neural network model 210 and the model. The result 220 for the action is understood to mean information necessary for the reinforcement learning of the neural network model 210. When the neural network model 210 acts, a state of the result is changed as a result 220 for the action and the model 210 is rewarded for the action. A goal of the reinforcement learning is to train the neural network model 210 to receive as many rewards as possible from the result 220 for the action.

According to an exemplary embodiment of the present disclosure, the processor 110 trains the neural network model by means of reinforcement learning based on a state including information about the semiconductor device, an action of disposing the semiconductor devices in a predetermined order, and the reward based on the action.

The processor 110 performs an operation of identifying an area in which the semiconductor device is not able to be disposed based on the information about the semiconductor device to be disposed, using the neural network model, and calculates a reward for the neural network model based on the area in which the semiconductor device is not able to be disposed to return the reward together with the state. By doing this, the neural network model performs the action according to a next cycle to perform the reinforcement learning for the neural network model.

For example, the processor 110 performs a specific order (n-th) action of disposing the semiconductor device in a canvas by means of the neural network model. The processor 110 estimates a reward Rn for the specific order (n-th) action and returns a state Sn of the result for the action and an estimated reward Rn to the neural network model. The processor 110 inputs the state and the reward of the result for the specific order (n-th) action to the neural network model to perform a next timing n+1-th action. The processor 110 repeats the cycle to perform the reinforcement learning for the neural network model to optimize the semiconductor design.

FIG. 4 is a flowchart illustrating a neural network model training method for a semiconductor design according to an exemplary embodiment of the present disclosure.

Referring to FIG. 4, the computing device 100 according to the exemplary embodiment of the present disclosure receives information about the semiconductor device from an external system (S110). The external system may be a server or a database which stores and manages information for a logical design of the semiconductor. The computing device 100 uses information received from the external system as input data for learning of the neural network model for a semiconductor design. The computing device 100 uses information received from the external system as input data for an operation (inference) of the neural network model for a semiconductor design. An aspect of using the information may vary in accordance with a purpose of learning or operation (inference) of the neural network model.

The computing device 100 may train the neural network model to dispose the semiconductor devices in the canvas in a predetermined order based on the information of the semiconductor device (S120). At this time, the learning of the neural network model may be performed based on the reinforcement learning. For example, the computing device 100 performs the reinforcement learning on the neural network model by performing an action of disposing the semiconductor devices in the canvas in a predetermined order by inputting information about the semiconductor device to the neural network model and returning the reward according to the action to the neural network model.

When the devices are disposed in the canvas in a predetermined order, the computing device 100 identifies an area in which the semiconductor device is not able to be disposed based on the placement information of one or more semiconductor devices disposed prior to the semiconductor device and the placement order of the semiconductor device, using the neural network model trained in step S120 (S130). The computing device 100 trains the neural network model by means of a neural network model reward assigning step of A or B, based on the area identified in step S130 to effectively dispose the semiconductor device in the canvas. The computing device 100 reduces a design cost and a variation of a design quality which are the problems of an existing design method, using the neural network model trained by the reinforcement learning.

According to the exemplary embodiment of the present disclosure, a state to enter as an input of the neural network model may include information representing a characteristic of the semiconductor device itself. For example, information representing characteristic of the device itself may include size information including a width or a height of the semiconductor device. The information representing the characteristic may include type information representing whether the semiconductor device is a macro cell. The information of the example as described above is understood as information for allowing the neural network model to identify a semiconductor device to be disposed at a specific timing.

According to the exemplary embodiment of the present disclosure, a state to enter as an input of the neural network model may include information about placement between the semiconductor devices. For example, the information about the placement may include index information regarding the placement order of the semiconductor device. The neural network model may be trained to dispose the semiconductor devices in the canvas in a predetermined order by means of the index information.

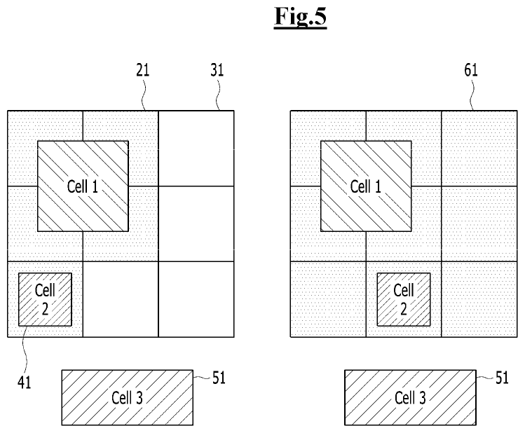

According to an exemplary embodiment of the present disclosure, the processor 110 inputs the state including the information of the semiconductor device to the neural network model to perform an action of disposing the semiconductor devices in the canvas in the predetermined order. At this time, the action of disposing the semiconductor devices in the canvas may include an action of disposing a mask in the canvas in an area in which a semiconductor device of a previous order has been already located or a space for disposing a specific ordered device is insufficient so that the device is not able to be disposed and disposing a semiconductor device in a canvas area in which the mask is not disposed. Specifically, referring to FIG. 5, when the action of disposing a semiconductor device based on the state including information of the semiconductor device is performed, the processor 110 may apply a mask to a canvas space which is divided by N*N (N is a natural number) grids. The mask may include an area in which the semiconductor device departs from the canvas and an area 21 overlapping the semiconductor device which has been already disposed in the canvas. When the mask is applied to the canvas, the processor 110 performs an action of disposing the semiconductor device in the remaining area 31 of the canvas to which the mask is not applied, by means of the neural network model. For example, when a next device 51 is disposed in a canvas space in which two devices are disposed, the neural network model of the processor 110 performs an action of disposing a next device 51 in an area 31 other than an area having the masks 21 based on the state including information of the semiconductor device. The mask is applied as described above so that the neural network model performs an efficient and accurate action in consideration of a physical environment of the canvas.

When the device is disposed according to a predetermined order, a size of an area in which the next semiconductor device 51 is to be disposed may vary depending on a position of the device 41 which is disposed in a previous order. At this time, a case in which an area in which a next device is not able to be disposed corresponds to the entire canvas space according to the location of the device disposed in a previous order (61) (that is, all zero masks) may occur. When such a case 61 occurs, no more device is able to be disposed so that in order to increase the semiconductor design efficiency, the neural network model needs to be trained to exclude a case in which the area in which the device is not able to be disposed is the entire area (61).

According to the exemplary embodiment of the present disclosure, the processor 110 estimates a reward based on an action of the neural network model based on a state including information of the semiconductor device.

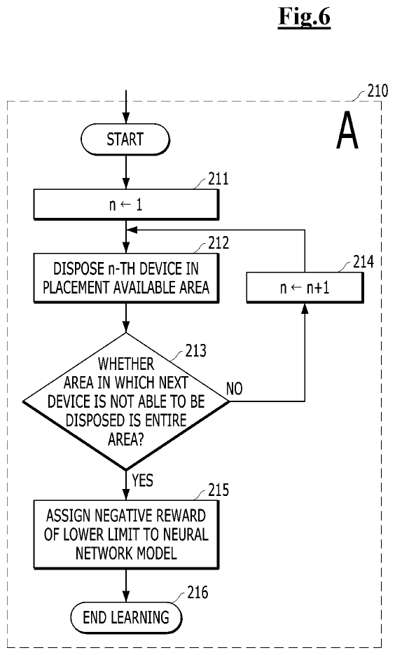

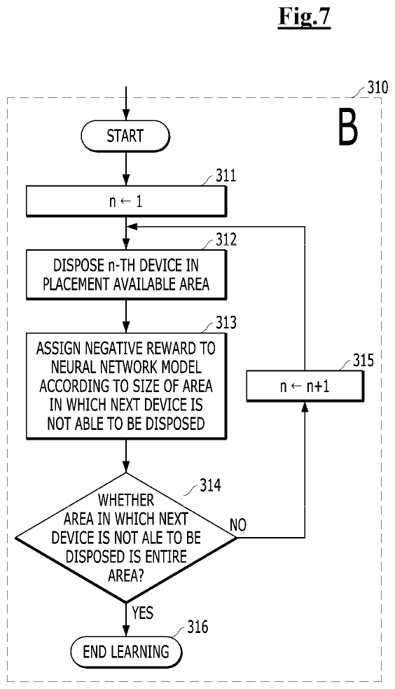

At this time, the step of calculating and assigning a reward to the neural network model includes one of a step A corresponding to FIG. 6 and a step B corresponding to FIG. 7, but is not limited thereto.

According to the exemplary embodiment of the present disclosure, the reward for the neural network model may include a reward corresponding to a lower limit of a negative reward when an area in which the semiconductor device is not able to be disposed corresponds to the entire area. Further, when the area in which the semiconductor device is not able to be disposed corresponds to the entire area, the neural network model ends the collection of information about the reinforcement learning.

Referring to FIGS. 5 and 6, FIG. 6 is an algorithm flowchart 210 illustrating a step A of the step of calculating and assigning a reward for the neural network model.

Specifically, an order assigned to a device which is disposed first in the step of identifying an area in which the semiconductor device is not able to be disposed based on placement information and a placement order of the semiconductor device and assigning a reward to the neural network model by the processor 110 is 1 (211). Next, the first device is disposed in an area excluding the identified area in which the device is not able to be disposed (212). At this time, the neural network model determines whether an area in which a next device is not able to be disposed corresponds to the entire area (213).

After determining whether to correspond, if the area in which the semiconductor device is not able to be disposed is not the entire area, an order 2 is assigned to a device to be disposed (214). This process is repeated until the area in which a next device is not able to be disposed corresponds to the entire area.

When the area in which the next device is not able to be disposed corresponds to the entire area, a negative reward with a lower limit is assigned to the neural network model (215). At this time, the reward includes a length wirelength of a wire which connects the semiconductor devices disposed on the canvas by means of the action and a congestion of semiconductor devices disposed on the canvas by means of the action. For example, the reward may be calculated as a weighted sum of the wire length and the congestion. For example, as the negative reward of the lower limit, a lower limit of the negative reward, 2, is assigned from a lower limit of −1 of the half-perimeter wirelength reward (HPWL) and a lower limit of −1 of a congestion reward. When the placement impossible area is the entire area, the negative reward of the lower limit is assigned to the neural network model to induce to exclude the case that the placement impossible area is the entire area from the reinforcement learning process. Additionally, when the placement impossible area is the entire area, the step of ending the information collection about the reinforcement learning path and the reinforcement learning by the neural network model may be included (216). The case that the next semiconductor device is not able to be disposed is induced to be excluded from the reinforcement learning process so that the efficiency of the semiconductor design is enhanced.

Referring to FIGS. 5 and 7, FIG. 7 is an algorithm flowchart 310 illustrating a step B of the step of calculating and assigning a reward for the neural network model.

Specifically, an order assigned to a device which is disposed first in the step of identifying an area in which the semiconductor device is not able to be disposed based on placement information and a placement order of the semiconductor device and assigning a reward to the neural network model by the processor 110 is 1 (311). Next, the first device is disposed in an area excluding the identified area in which the device is not able to be disposed (312). At this time, the reward for the neural network model includes a negative reward which is determined in proportion to the size of the area in which the semiconductor device is not able to be disposed (313). Specifically, the reward for the neural network model may include an n-th negative reward determined based on the size of the area in which an n-th semiconductor device is not able to be disposed and a n+1-th negative reward determined based on a size of the area in which an n+1-th semiconductor device to be disposed after the n-th semiconductor device is not able to be disposed. For example, the negative reward determined in proportion to the size of the area in which the semiconductor device is not able to be disposed includes a case calculated as one value between the following equations. The expressed equations are merely examples, but the negative reward is not limited thereto.

Negative reward=−(Number of masked grids/Total number of grids of canvas) [Equation 1]

Negative reward=−log(Number of masked grids/Total number of grids of canvas) [Equation 2]

Next, the neural network model determines whether an area in which a next device is not able to be disposed corresponds to the entire area (314). After determining whether to correspond, if the area in which the semiconductor device is not able to be disposed is not the entire area, an order 2 is assigned to a device to be disposed (315). This process is repeated until the area in which a next device is not able to be disposed corresponds to the entire area. When the area in which the next device is not able to be disposed corresponds to the entire area, a step of ending the learning of the neural network model may be included (316). The neural network model is trained to expand a size of the area in which a next device can be disposed whenever a specific order of the semiconductor device is disposed to increase the semiconductor design efficiency.

Disclosed is a computer readable medium storing the data structure according to an exemplary embodiment of the present disclosure.

The data structure may refer to the organization, management, and storage of data that enables efficient access to and modification of data. The data structure may refer to the organization of data for solving a specific problem (e.g., data search, data storage, data modification in the shortest time). The data structures may be defined as physical or logical relationships between data elements, designed to support specific data processing functions. The logical relationship between data elements may include a connection between data elements that the user defines. The physical relationship between data elements may include an actual relationship between data elements physically stored on a computer-readable storage medium (e.g., persistent storage device). The data structure may specifically include a set of data, a relationship between the data, a function which may be applied to the data, or instructions. Through an effectively designed data structure, a computing device can perform operations while using the resources of the computing device to a minimum. Specifically, the computing device can increase the efficiency of operation, read, insert, delete, compare, exchange, and search through the effectively designed data structure.

The data structure may be divided into a linear data structure and a non-linear data structure according to the type of data structure. The linear data structure may be a structure in which only one data is connected after one data. The linear data structure may include a list, a stack, a queue, and a deque. The list may mean a series of data sets in which an order exists internally. The list may include a linked list. The linked list may be a data structure in which data is connected in a scheme in which each data is linked in a row with a pointer. In the linked list, the pointer may include link information with next or previous data. The linked list may be represented as a single linked list, a double linked list, or a circular linked list depending on the type. The stack may be a data listing structure with limited access to data. The stack may be a linear data structure that may process (e.g., insert or delete) data at only one end of the data structure. The data stored in the stack may be a data structure (LIFO-Last in First Out) in which the data is input last and output first. The queue is a data listing structure that may access data limitedly and unlike a stack, the queue may be a data structure (FIFO-First in First Out) in which late stored data is output late. The deque may be a data structure capable of processing data at both ends of the data structure.

The non-linear data structure may be a structure in which a plurality of data are connected after one data. The non-linear data structure may include a graph data structure. The graph data structure may be defined as a vertex and an edge, and the edge may include a line connecting two different vertices. The graph data structure may include a tree data structure. The tree data structure may be a data structure in which there is one path connecting two different vertices among a plurality of vertices included in the tree. That is, the tree data structure may be a data structure that does not form a loop in the graph data structure.

The data structure may include the neural network. In addition, the data structures, including the neural network, may be stored in a computer readable medium. The data structure including the neural network may also include data preprocessed for processing by the neural network, data input to the neural network, weights of the neural network, hyper parameters of the neural network, data obtained from the neural network, an active function associated with each node or layer of the neural network, and a loss function for learning the neural network. The data structure including the neural network may include predetermined components of the components disclosed above. In other words, the data structure including the neural network may include all of data preprocessed for processing by the neural network, data input to the neural network, weights of the neural network, hyper parameters of the neural network, data obtained from the neural network, an active function associated with each node or layer of the neural network, and a loss function for learning the neural network or a combination thereof. In addition to the above-described configurations, the data structure including the neural network may include predetermined other information that determines the characteristics of the neural network. In addition, the data structure may include all types of data used or generated in the calculation process of the neural network, and is not limited to the above. The computer readable medium may include a computer readable recording medium and/or a computer readable transmission medium. The neural network may be generally constituted by an aggregate of calculation units which are mutually connected to each other, which may be called nodes. The nodes may also be called neurons. The neural network is configured to include one or more nodes.

The data structure may include data input into the neural network. The data structure including the data input into the neural network may be stored in the computer readable medium. The data input to the neural network may include learning data input in a neural network learning process and/or input data input to a neural network in which learning is completed. The data input to the neural network may include preprocessed data and/or data to be preprocessed. The preprocessing may include a data processing process for inputting data into the neural network. Therefore, the data structure may include data to be preprocessed and data generated by preprocessing. The data structure is just an example and the present disclosure is not limited thereto.

The data structure may include the weight of the neural network (in the present disclosure, the weight and the parameter may be used as the same meaning). In addition, the data structures, including the weight of the neural network, may be stored in the computer readable medium. The neural network may include a plurality of weights. The weight may be variable and the weight is variable by a user or an algorithm in order for the neural network to perform a desired function. For example, when one or more input nodes are mutually connected to one output node by the respective links, the output node may determine a data value output from an output node based on values input in the input nodes connected with the output node and the weights set in the links corresponding to the respective input nodes. The data structure is just an example and the present disclosure is not limited thereto.

As a non-limiting example, the weight may include a weight which varies in the neural network learning process and/or a weight in which neural network learning is completed. The weight which varies in the neural network learning process may include a weight at a time when a learning cycle starts and/or a weight that varies during the learning cycle. The weight in which the neural network learning is completed may include a weight in which the learning cycle is completed. Accordingly, the data structure including the weight of the neural network may include a data structure including the weight which varies in the neural network learning process and/or the weight in which neural network learning is completed. Accordingly, the above-described weight and/or a combination of each weight are included in a data structure including a weight of a neural network. The data structure is just an example and the present disclosure is not limited thereto.

The data structure including the weight of the neural network may be stored in the computer-readable storage medium (e.g., memory, hard disk) after a serialization process. Serialization may be a process of storing data structures on the same or different computing devices and later reconfiguring the data structure and converting the data structure to a form that may be used. The computing device may serialize the data structure to send and receive data over the network. The data structure including the weight of the serialized neural network may be reconfigured in the same computing device or another computing device through deserialization. The data structure including the weight of the neural network is not limited to the serialization. Furthermore, the data structure including the weight of the neural network may include a data structure (for example, B-Tree, Trie, m-way search tree, AVL tree, and Red-Black Tree in a nonlinear data structure) to increase the efficiency of operation while using resources of the computing device to a minimum. The above-described matter is just an example and the present disclosure is not limited thereto.

The data structure may include hyper-parameters of the neural network. In addition, the data structures, including the hyper-parameters of the neural network, may be stored in the computer readable medium. The hyper-parameter may be a variable which may be varied by the user. The hyper-parameter may include, for example, a learning rate, a cost function, the number of learning cycle iterations, weight initialization (for example, setting a range of weight values to be subjected to weight initialization), and Hidden Unit number (e.g., the number of hidden layers and the number of nodes in the hidden layer). The data structure is just an example and the present disclosure is not limited thereto.

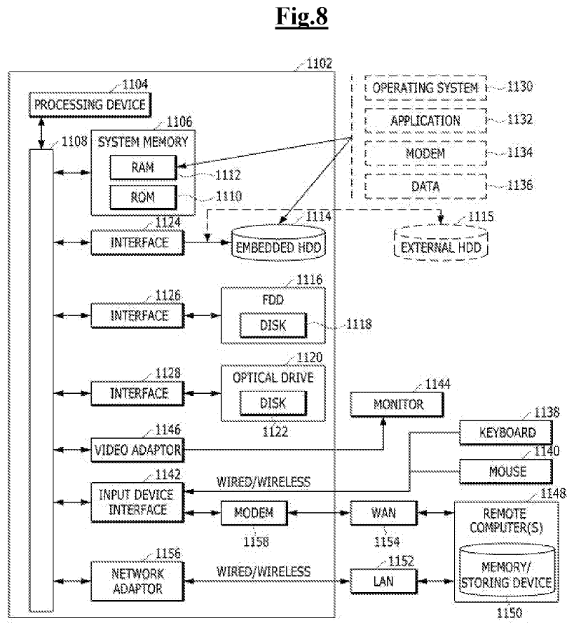

FIG. 8 is a normal and schematic view of an exemplary computing environment in which the exemplary embodiments of the present disclosure may be implemented.

It is described above that the present disclosure may be generally implemented by the computing device, but those skilled in the art will well know that the present disclosure may be implemented in association with a computer executable command which may be executed on one or more computers and/or in combination with other program modules and/or a combination of hardware and software.

In general, the program module includes a routine, a program, a component, a data structure, and the like that execute a specific task or implement a specific abstract data type. Further, it will be well appreciated by those skilled in the art that the method of the present disclosure can be implemented by other computer system configurations including a personal computer, a handheld computing device, microprocessor-based or programmable home appliances, and others (the respective devices may operate in connection with one or more associated devices as well as a single-processor or multi-processor computer system, a mini computer, and a main frame computer.

The exemplary embodiments described in the present disclosure may also be implemented in a distributed computing environment in which predetermined tasks are performed by remote processing devices connected through a communication network. In the distributed computing environment, the program module may be positioned in both local and remote memory storage devices.

The computer generally includes various computer readable media. Media accessible by the computer may be computer readable media regardless of types thereof and the computer readable media include volatile and non-volatile media, transitory and non-transitory media, and mobile and non-mobile media. As a non-limiting example, the computer readable media may include both computer readable storage media and computer readable transmission media. The computer readable storage media include volatile and non-volatile media, transitory and non-transitory media, and mobile and non-mobile media implemented by a predetermined method or technology for storing information such as a computer readable instruction, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The computer readable transmission media generally implement the computer readable command, the data structure, the program module, or other data in a carrier wave or a modulated data signal such as other transport mechanism and include all information transfer media. The term “modulated data signal” means a signal acquired by setting or changing at least one of characteristics of the signal so as to encode information in the signal. As a non-limiting example, the computer readable transmission media include wired media such as a wired network or a direct-wired connection and wireless media such as acoustic, RF, infrared and other wireless media. A combination of any media among the aforementioned media is also included in a range of the computer readable transmission media.

An exemplary environment 1100 that implements various aspects of the present disclosure including a computer 1102 is shown and the computer 1102 includes a processing device 1104, a system memory 1106, and a system bus 1108. The system bus 1108 connects system components including the system memory 1106 (not limited thereto) to the processing device 1104. The processing device 1104 may be a predetermined processor among various commercial processors. A dual processor and other multi-processor architectures may also be used as the processing device 1104.

The system bus 1108 may be any one of several types of bus structures which may be additionally interconnected to a local bus using any one of a memory bus, a peripheral device bus, and various commercial bus architectures. The system memory 1106 includes a read only memory (ROM) 1110 and a random access memory (RAM) 1112. A basic input/output system (BIOS) is stored in the non-volatile memories 1110 including the ROM, the EPROM, the EEPROM, and the like and the BIOS includes a basic routine that assists in transmitting information among components in the computer 1102 at a time such as in-starting. The RAM 1112 may also include a high-speed RAM including a static RAM for caching data, and the like.

The computer 1102 also includes an interior hard disk drive (HDD) 1114 (for example, EIDE and SATA), in which the interior hard disk drive 1114 may also be configured for an exterior purpose in an appropriate chassis (not illustrated), a magnetic floppy disk drive (FDD) 1116 (for example, for reading from or writing in a mobile diskette 1118), and an optical disk drive 1120 (for example, for reading a CD-ROM disk 1122 or reading from or writing in other high-capacity optical media such as the DVD, and the like). The hard disk drive 1114, the magnetic disk drive 1116, and the optical disk drive 1120 may be connected to the system bus 1108 by a hard disk drive interface 1124, a magnetic disk drive interface 1126, and an optical drive interface 1128, respectively. An interface 1124 for implementing an exterior drive includes at least one of a universal serial bus (USB) and an IEEE 1394 interface technology or both of them.

The drives and the computer readable media associated therewith provide non-volatile storage of the data, the data structure, the computer executable instruction, and others. In the case of the computer 1102, the drives and the media correspond to storing of predetermined data in an appropriate digital format. In the description of the computer readable media, the mobile optical media such as the HDD, the mobile magnetic disk, and the CD or the DVD are mentioned, but it will be well appreciated by those skilled in the art that other types of media readable by the computer such as a zip drive, a magnetic cassette, a flash memory card, a cartridge, and others may also be used in an exemplary operating environment and further, the predetermined media may include computer executable commands for executing the methods of the present disclosure.

Multiple program modules including an operating system 1130, one or more application programs 1132, other program module 1134, and program data 1136 may be stored in the drive and the RAM 1112. All or some of the operating system, the application, the module, and/or the data may also be cached in the RAM 1112. It will be well appreciated that the present disclosure may be implemented in operating systems which are commercially usable or a combination of the operating systems.

A user may input instructions and information in the computer 1102 through one or more wired/wireless input devices, for example, pointing devices such as a keyboard 1138 and a mouse 1140. Other input devices (not illustrated) may include a microphone, an IR remote controller, a joystick, a game pad, a stylus pen, a touch screen, and others. These and other input devices are often connected to the processing device 1104 through an input device interface 1142 connected to the system bus 1108, but may be connected by other interfaces including a parallel port, an IEEE 1394 serial port, a game port, a USB port, an IR interface, and others.

A monitor 1144 or other types of display devices are also connected to the system bus 1108 through interfaces such as a video adapter 1146, and the like. In addition to the monitor 1144, the computer generally includes other peripheral output devices (not illustrated) such as a speaker, a printer, others.

The computer 1102 may operate in a networked environment by using a logical connection to one or more remote computers including remote computer(s) 1148 through wired and/or wireless communication. The remote computer(s) 1148 may be a workstation, a computing device computer, a router, a personal computer, a portable computer, a microprocessor based entertainment apparatus, a peer device, or other general network nodes and generally includes multiple components or all of the components described with respect to the computer 1102, but only a memory storage device 1150 is illustrated for brief description. The illustrated logical connection includes a wired/wireless connection to a local area network (LAN) 1152 and/or a larger network, for example, a wide area network (WAN) 1154. The LAN and WAN networking environments are general environments in offices and companies and facilitate an enterprise-wide computer network such as Intranet, and all of them may be connected to a worldwide computer network, for example, the Internet.

When the computer 1102 is used in the LAN networking environment, the computer 1102 is connected to a local network 1152 through a wired and/or wireless communication network interface or an adapter 1156. The adapter 1156 may facilitate the wired or wireless communication to the LAN 1152 and the LAN 1152 also includes a wireless access point installed therein in order to communicate with the wireless adapter 1156. When the computer 1102 is used in the WAN networking environment, the computer 1102 may include a modem 1158 or has other means that configure communication through the WAN 1154 such as connection to a communication computing device on the WAN 1154 or connection through the Internet. The modem 1158 which may be an internal or external and wired or wireless device is connected to the system bus 1108 through the serial port interface 1142. In the networked environment, the program modules described with respect to the computer 1102 or some thereof may be stored in the remote memory/storage device 1150. It will be well known that an illustrated network connection is exemplary and other means configuring a communication link among computers may be used.

The computer 1102 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and Bluetooth wireless technology. Accordingly, communication may be a predefined structure like the network in the related art or just ad hoc communication between at least two devices.

The wireless fidelity (Wi-Fi) enables connection to the Internet, and the like without a wired cable. The Wi-Fi is a wireless technology such as the device, for example, a cellular phone which enables the computer to transmit and receive data indoors or outdoors, that is, anywhere in a communication range of a base station. The Wi-Fi network uses a wireless technology called IEEE 802.11 (a, b, g, and others) in order to provide safe, reliable, and high-speed wireless connection. The Wi-Fi may be used to connect the computers to each other or the Internet and the wired network (using IEEE 802.3 or Ethernet). The Wi-Fi network may operate, for example, at a data rate of 11 Mbps (802.11a) or 54 Mbps (802.11b) in unlicensed 2.4 and 5 GHz wireless bands or operate in a product including both bands (dual bands).

It will be appreciated by those skilled in the art that information and signals may be expressed by using various different predetermined technologies and techniques. For example, data, instructions, commands, information, signals, bits, symbols, and chips which may be referred in the above description may be expressed by voltages, currents, electromagnetic waves, magnetic fields or particles, optical fields or particles, or predetermined combinations thereof.

It may be appreciated by those skilled in the art that various exemplary logical blocks, modules, processors, means, circuits, and algorithm steps described in association with the exemplary embodiments disclosed herein may be implemented by electronic hardware, various types of programs or design codes (for easy description, herein, designated as software), or a combination of all of them. In order to clearly describe the intercompatibility of the hardware and the software, various exemplary components, blocks, modules, circuits, and steps have been generally described above in association with functions thereof. Whether the functions are implemented as the hardware or software depends on design restrictions given to a specific application and an entire system. Those skilled in the art of the present disclosure may implement functions described by various methods with respect to each specific application, but it should not be interpreted that the implementation determination departs from the scope of the present disclosure.

Various exemplary embodiments presented herein may be implemented as manufactured articles using a method, a device, or a standard programming and/or engineering technique. The term manufactured article includes a computer program, a carrier, or a medium which is accessible by a predetermined computer-readable storage device. For example, a computer-readable storage medium includes a magnetic storage device (for example, a hard disk, a floppy disk, a magnetic strip, or the like), an optical disk (for example, a CD, a DVD, or the like), a smart card, and a flash memory device (for example, an EEPROM, a card, a stick, a key drive, or the like), but is not limited thereto. Further, various storage media presented herein include one or more devices and/or other machine-readable media for storing information.

It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Appended method claims provide elements of various steps in a sample order, but the method claims are not limited to the presented specific order or hierarchical structure.

The description of the presented exemplary embodiments is provided so that those skilled in the art of the present disclosure use or implement the present disclosure. Various modifications of the exemplary embodiments will be apparent to those skilled in the art and general principles defined herein can be applied to other exemplary embodiments without departing from the scope of the present disclosure. Therefore, the present disclosure is not limited to the exemplary embodiments presented herein, but should be interpreted within the widest range which is coherent with the principles and new features presented herein.

What is claimed is:

1. A method for a semiconductor design, the method performed by one or more processors of a computing device, the method comprising:
identifying an area in which a semiconductor device is not able to be disposed based on information about the semiconductor device to be disposed, using a neural network model; and
calculating a reward for the neural network model based on the area in which the semiconductor device is not able to be disposed,
wherein the reward for the neural network model includes a reward corresponding to a lower limit of a negative reward when an area in which the semiconductor device is not able to be disposed corresponds to an entire area.

2. The method according to claim 1, wherein the information about the semiconductor device includes at least one of:
size information including at least one of a width or a height of the semiconductor device; or
type information of the semiconductor device.

3. The method according to claim 1, wherein the information about the semiconductor device includes index information about a placement order of the semiconductor device.

4. The method according to claim 1, wherein the neural network model is trained by means of reinforcement learning based on a state including information about the semiconductor device, an action to dispose the semiconductor devices in a predetermined order, and a reward for the action.

5. The method according to claim 4, wherein the neural network model identifies the area in which the semiconductor device is not able to be disposed, based on the placement information of one or more semiconductor devices disposed prior to the semiconductor device, and a placement order of the semiconductor device.

6. The method according to claim 5, wherein the reward for the neural network model includes a negative reward determined in proportion to a size of the area in which the semiconductor device is not able to be disposed.

7. The method according to claim 6, wherein the reward for the neural network model includes:
a first negative reward determined based on a size of an area in which the first semiconductor device is not able to be disposed; and
a second negative reward determined based on a size of an area in which a second semiconductor device to be disposed after the first semiconductor device is not able to be disposed.

8. The method according to claim 1, wherein when the area in which the semiconductor device is not able to be disposed corresponds to the entire area, the neural network model ends the collection of information about the reinforcement learning.

9. A computer program stored in a non-transitory computer readable storage medium, wherein the computer program causes one or more processors to perform operations for semiconductor design when the computer program is executed by the one or more processors, wherein the operations include:
an operation of identifying an area in which a semiconductor device is not disposed based on information about the semiconductor device to be disposed, using a neural network model; and
an operation of calculating a reward for the neural network model based on the area in which the semiconductor device cannot be disposed,
wherein the reward for the neural network model includes a reward corresponding to a lower limit of a negative reward when an area in which the semiconductor device cannot be disposed corresponds to an entire area.

10. A computing device, comprising:
at least one processor; and
a memory,
wherein the at least one processor is configured to:
identify an area in which a semiconductor device is not disposed based on information about the semiconductor device to be disposed, using a neural network model; and
calculate a reward for the neural network model based on the area in which the semiconductor device cannot be disposed,
wherein the reward for the neural network model includes a reward corresponding to a lower limit of a negative reward when an area in which the semiconductor device cannot be disposed corresponds to an entire area.
